(19) United States
(12) Patent Application Publication
(10) Pub. No.: US 2019/0211927 A1
(43) Pub. Date: Jul. 11, 2019

(54) AUTOMOTIVE SYNCHRONIZER SLIDER ASSEMBLY

(71) Applicant: Jiaxing OnRoll Machinery Co., Ltd., Jiaxing City (CH)

(72) Inventors: LIPING ZHOU, JIAXING CITY (CH); WEI ZHOU, Jiaxing City (CH)

(21) Appl. No.: 16/244,616

(22) Filed: Jan. 10, 2019

Related U.S. Application Data
(60) Provisional application No. 62/615,692, filed on Jan. 10, 2018.

(51) Int. Cl. F16H 63/34; F16D 23/06; F16H 57/023

(52) U.S. Cl. CPC F16H 63/3408; F16D 23/06; F16D 2023/0631; F16D 2023/0618; F16H 57/023

(57) ABSTRACT

An automotive synchronizer slider assembly includes a slider body with two connecting grooves symmetrically arranged thereon. The slider body has a top, a bottom, and a middle. A first boss and a second boss are provided on the top of the slider body. The first boss and the second boss have mounting grooves for a steel ball, and the first boss has provided on a top thereof two or more clips. Pressure plates are provided at the bottom of the slider body. A mounting part has a top and a bottom, and a spring mounting hole positioned between the top and the bottom. The top of the mounting part is connected to the second boss, and the bottom of the mounting part has a hole therein. A steel ball is mounted in the mounting grooves and retained in the slider body by the two clips. A fastening spring having a top and a bottom is mounted in the spring mounting hole. The bottom of the fastening spring abuts the bottom of the mounting part proximate the hole therein, and the top of the fastening spring abuts the steel ball.

### CROSS-REFERENCE TO RELATED APPLICATIONS

The present application is related to, and claims the benefit of priority from, U.S. Provisional Application Ser. No. 62/615692, filed 10 Jan. 2018, the disclosure of which is incorporated herein by reference in its entirety.

### FIELD OF THE INVENTION

The present invention pertains to the field of the automobile parts and, more particularly, to the field of automobile synchronizer slider assemblies.

### BACKGROUND

The synchronizer is an important component in the automotive transmission shift operating mechanism. It can effectively avoid the gear impact during the gearshift and ensure that the gearshift process is carried out quickly and smoothly. Synchronizers can be divided into atmospheric synchronizers, inertial synchronizers, and self-energizing synchronizers. The one commonly used at present is the inertial lock synchronizer, which is equipped with synchronizer ring, slider components, hubs, and gear sleeves. The slider components have a certain effect on the final performance of the synchronizer. More particularly, the slider assembly, also sometimes referred to as a detent strut, key, or centering mechanism, is a component of the synchronizer that is arranged on a circumference of the synchronizer hub, positioned between a groove in the synchronizer hub and an inner groove in the shift sleeve. The slider assembly is therefore rotatable with the synchronizer hub, and moves axially with the shift sleeve. Three or more such slider assemblies are typically provided, being spaced apart equidistantly on the synchronizer hub. The slider assembly serves through its construction to maintain the shift sleeve in position on the synchronizer hub, and generates a load on the synchronizer ring to facilitate presynchronization.

### SUMMARY OF THE DISCLOSURE

An automotive synchronizer slider assembly comprises a slider body having two connecting grooves symmetrically arranged thereon. The slider body has a top, a bottom, and a middle. A first boss and a second boss are provided on the top of the slider body. Both the first boss and the second boss include mounting grooves for a steel ball. The first boss has on a top thereof at least two clips. At least two pressure plates are provided at the bottom of the slider body. A mounting part has a top and a bottom and a spring mounting hole positioned between the top and the bottom. The top of the mounting part is connected to the second boss, and the bottom of the mounting part has a hole therein. A steel ball is mounted in the mounting grooves and retained in the slider body by the at least two clips. A fastening spring has a top and a bottom, and is mounted in the spring mounting hole. The bottom of the fastening spring abuts the bottom of the mounting part proximate the hole therein, and the top of the fastening spring abuts the steel ball.

Per one feature, the first boss is fixed on the top of the second boss, and a face diameter of the second boss is larger than a face diameter of the first boss.

According to another feature, the at least two clips are symmetrically distributed on the first boss and dimensioned to seize the outside of the steel ball.

Per still another feature, the width of the fastening spring is larger than the diameter of the hole in the bottom of the mounting part, and the mounting part is characterized by a diameter proximate the top of the mounting part which is smaller than the diameter of the mounting part proximate the bottom of the mounting part.

According to a further feature, the steel ball, the mounting part, and the slider body are coaxially arranged along the same longitudinal axis defined through the center of the hole in the bottom of the mounting part and extending through the center of the spring mounting hole and the top of the mounting part. Further, an upper end of the spring mounting hole coincides with a bottom surface of the steel ball mounting groove.

### BRIEF DESCRIPTION OF THE DRAWINGS

The features and advantages of the present invention will be better understood with reference to the written description and drawings, of which:

FIG. 1 is a front view of the automotive synchronizer slider assembly of the present invention;

FIG. 2 is a top view of the automotive synchronizer slider assembly of the present invention;

FIG. 3 is a bottom view of the automotive synchronizer slider assembly of the present invention;

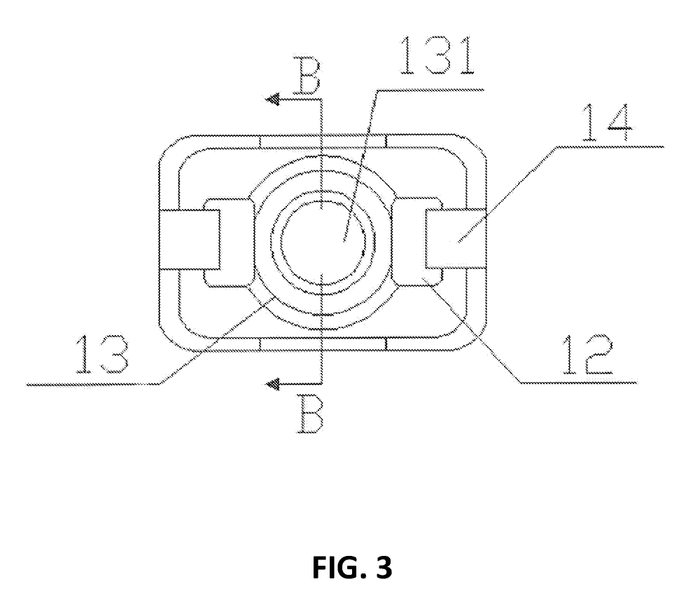

FIG. 4 is a cross-sectional view of the automotive synchronizer slider assembly of present invention, taken along lines A-A of FIG. 2; and

FIG. 5 is a cross-sectional view of the automotive synchronizer slider assembly of the present invention, taken along lines B-B of FIG 3.

### DETAILED DESCRIPTION

Referring now to the drawings, wherein like numerals indicate like or corresponding parts throughout the several views, the present invention will be seen to comprise an automotive synchronizer slider assembly for a vehicle transmission system. The slider assembly includes a slider body (1) with each of a top, a bottom, and a middle. Two connecting grooves (15) are symmetrically arranged on the slider body.

A first boss (11) and a second boss (16) are provided on the top of the slider body (1). Both the first boss (11) and the second boss (16) include mounting grooves for a steel ball (2), and the first boss (11) has provided on a top thereof at least two clips (12).

At least two pressure plates (14) are provided at the bottom of the slider body (1).

A mounting part (13) has a spring mounting hole positioned between the top and the bottom of the mounting part. The top of the mounting part (13) is connected to the second boss (16); the bottom of the mounting part (13) has a hole (131) therein.

A steel ball (2) is mounted in the mounting grooves of the first boss (11) and the second boss (16) and retained in the slider body (1) by the at least two clips (12).

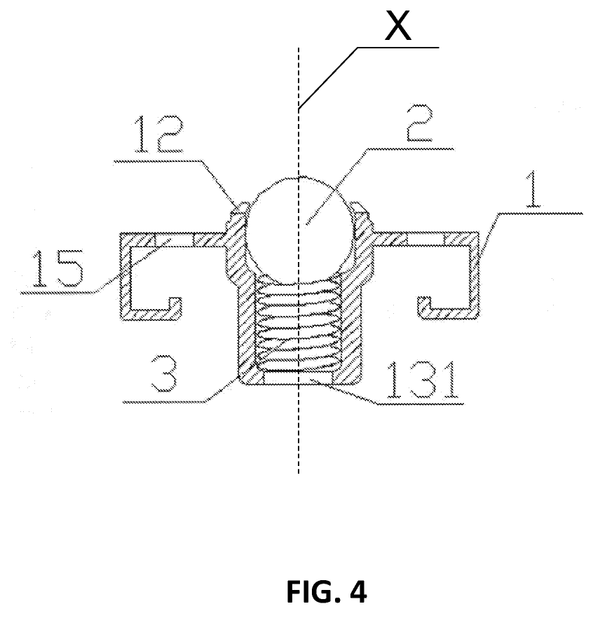

A fastening spring (3) having a top and a bottom is mounted in the spring mounting hole, as best seen in FIG. 4, with the bottom of the fastening spring (3) abutting the bottom of the mounting part (13) proximate the hole (131) therein, and the top of the fastening spring abutting the steel ball (2).

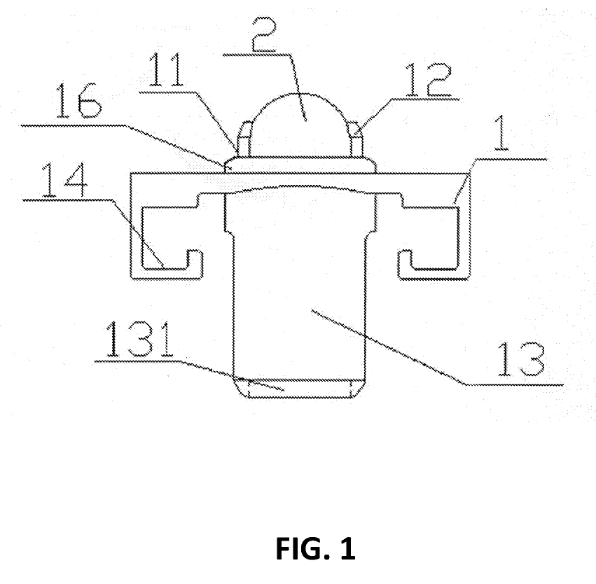

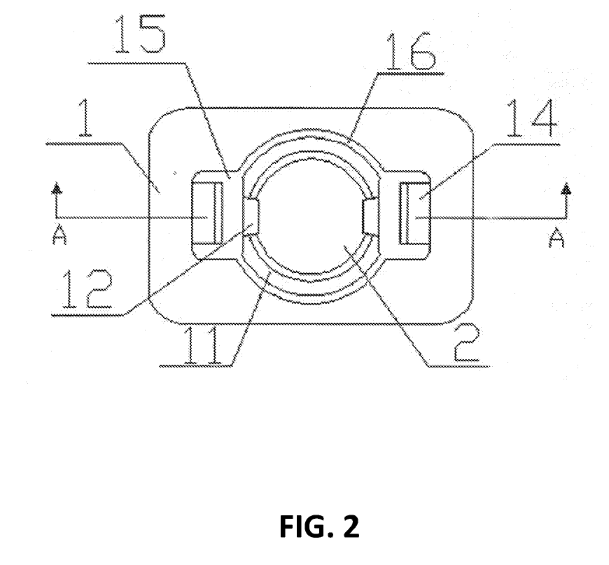

The first boss (11) is fixed on the top of the second boss (16) anti a face diameter of the second boss (16) is larger than a face diameter of the first boss (11), as best seen in FIGS. 1 and 2.

In the illustrated embodiment, two clips (12) are provided which are symmetrically distributed on the first boss (11), as best seen in FIGS. 2 and 4. The clips (12) are dimensioned to seize the outside of the steel ball (2), as best shown in FIGS. 1 and 4.

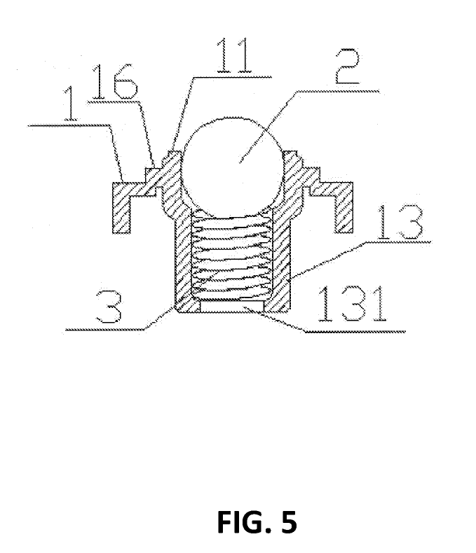

The width of the fastening spring (3) is larger than the diameter of the hole (131) in the bottom of the mounting part (13), as best seen in FIG. 5.

The mounting part (13) is also characterized, in the illustrated embodiment, by a diameter proximate the top of the mounting part which is smaller than the diameter of the mounting part proximate the bottom of the mounting part.

The steel ball (2), the mounting part (13), and the slider body (1) are coaxially arranged along the same longitudinal axis (the dashed line designated X in FIG. 4) defined through the center of the hole (131) in the bottom of the mounting part (13) and extending through the center of the spring mounting hole and the top of the mounting part.

An upper end of the spring mounting hole coincides with a bottom surface of the steel ball mounting groove, also as shown in FIG 4.

During assembly of the present invention, the fastening spring (3) is first placed into the spring mounting hole in the mounting part (13). Then the steel ball (2) is installed into the mounting groove so that the steel ball (2) abuts against both the clips (12) and the top of the spring (3), thereby fixing the steel ball (2) in the mounting grooves.

Per the present invention, the steel ball mounting grooves provided on the first boss (11) and the second boss (16) and the clips (12) on the first boss (11) make it easy to install the steel ball (2) in the slider body (1) and effectively avoids the fulling of the steel ball (2). The mounting part (13) in the middle of the slider body (1) has a spring mounting hole, as described, which makes it easy to install the fastening spring (3) without deformation. The present invention also connects the mounting part (13) with the second boss (16), realizing the integrated portable mounting of the spring, the slider and the steel ball, thereby improving the production efficiency.

As will be appreciated from the foregoing, the integrated automobile synchronizer slider assembly of the present invention makes the slider assembly easier to produce. The integrated structure of the spring, the slider and the steel ball avoids the falling of the steel ball effectively so as to improve the quality of the product. The fixed clips on the first boss make the steel ball easy to be installed in the slider body and effectively avoids the falling of the steel ball. There is a mounting part in the middle of the slider body and inside the mounting part there is a spring mounting hole, making the fastening spring easy to be installed and not easy to deform. It connects the mounting part with the second boss, realizing the integrated portable mounting of the spring, the slider and the steel ball, improving the production efficiency; the structure of the slider components and the assembly are simple, thus reducing the production costs. This is advantageous in comparison to prior art integrated automotive synchronizer slider assemblies, which are complicated in construction and difficult to manufacture.

Of course, many modifications and variations of the present invention are possible in light of the above teachings and may be practiced otherwise than as specifically described while within the scope of the appended claims.

1. An automotive synchronizer slider assembly, comprising:
a slider body having two connecting grooves symmetrically arranged thereon, the slider body including each of a top, a bottom, and a middle;
a first boss and a second boss provided on the top of the slider body, both the first boss and the second boss including mounting grooves for a steel ball, and the first boss having provided on a top thereof at feast two clips;
at least two pressure plates provided at the bottom of the slider body;
a mounting part having a top and a bottom and a spring mounting hole positioned between the top and the bottom, the top of the mounting part connected to the second boss, and the bottom of the mounting part having a hole therein;
a steel ball mounted in the mounting grooves and retained in the slider body by the at least two clips; and
a fastening spring having a top and a bottom, the fastening spring mounted in the spring mounting hole, the bottom of the fastening spring abutting the bottom of the mounting part proximate the hole therein, and the top of the fastening spring abutting the steel ball.

2. The automotive synchronizer slider assembly of claim 1, wherein the first boss is fixed on the top of she second boss and a face diameter of the second boss is larger than a face diameter of the first boss.

3. The automotive synchronizer slider assembly of claim 1, wherein the at least two clips are symmetrically distributed in the first boss and dimensioned to seize the outside of the steel ball.

4. The automotive synchronizer slider assembly of claim 1, wherein the width of the fastening spring is larger than the diameter of the hole in the bottom of the mounting part, and wherein further the mounting part is characterized by a diameter proximate the top of the mounting part which is smaller than the diameter of the mounting part proximate the bottom of the mounting part.

5. The automotive synchronizer slider assembly of claim 1, wherein the steel ball, the mounting part, and the slider body are coaxially arranged along the same longitudinal axis defined through the center of the hole in the bottom of the mounting part and extending through the center of the spring mounting hole and the top of the mourning part, and wherein further an upper end of the spring mounting hole coincides with a bottom surface of the steel bull mounting groove.

6. The automotive synchronizer slider assembly of claim 1, wherein the at least two clips are symmetrically distributed on the first boss and dimensioned to seize the outside of the steel ball.

7. The automotive synchronizer slider assembly of claim 6, wherein the width of the fastening spring is larger than the diameter of the hole in the bottom of the mounting part, and wherein further the mounting part is characterized by a diameter proximate the top of the mounting part which is smaller than the diameter of the mounting part proximate the bottom of the mounting part.

8. The automotive synchronize slider assembly of claim 7, wherein the steel ball, the mounting part, and the slider body are coaxially arranged along the same longitudinal axis defined through the center of the hole in the bottom of live mounting part and extending through the center of the spring mounting hole and the top of the mounting part, and wherein further an upper end of the spring mounting hole coincides with a bottom surface of the steel ball mounting groove.
